(19) United States
(12) Patent Application Publication
(10) Pub. No.: US 2010/0199543 A1
(43) Pub. Date: Aug. 12, 2010

(54) Spring Activated Adhesive Rodent Trap

(76) Inventor: Bernardo Beresnitzky, Brooklyn, NY (US)

Correspondence Address: Bernard Malina, Esq.;Malina & Associates, PLLC, 17th Floor, 444 Madison Avenue, New York, NY, 10022, US

(21) Appl. No.: 12/630,525

(22) Filed: Dec. 3, 2009

Related U.S. Application Data
(60) Provisional application No. 61/119,862, filed on Dec. 4, 2008.

(51) Int. Cl. A01M 23/00

(52) U.S. Cl. 43/58

(57) ABSTRACT

An adhesive rodent trap includes a base member on which an adhesive layer is deposited. A bi-stable spring member is attached to a lower surface of the base member. When a rodent ventures onto the adhesive layer, the spring snaps into a curved configuration and forces the base member into a curved state which envelopes and conceals the rodent.

### FIELD OF THE INVENTION

The present invention relates generally to rodent traps and more particularly, to a spring activated adhesive rodent trap.

### BACKGROUND OF THE INVENTION

The prior art related to rodent traps includes a range of devices which use an adhesive layer to trap a rodent that ventures onto the adhesive layer. These traps generally have an adhesive layer which is deposited on a generally flat or dish-shaped member. While effective, these traps have the disadvantage of leaving the remains of the rodent exposed on the adhesive layer. In addition, the adhesive layer often becomes attached to only a portion of the rodent's anatomy and the rodent is sometimes able to free itself from the adhesive layer and escape.

Despite the developments of the prior art, there remains a need for an adhesive rodent trap which entraps the rodent in a secure manner to prevent escape and also conceals the remains of the entrapped rodent.

### OBJECTS AND SUMMARY OF THE INVENTION

It is an object of the present invention to provide a spring activated adhesive rodent trap which envelops a trapped rodent.

Another object of the present invention is to provide a spring activated rodent trap which incorporates a bi-stable spring.

Another object of the present invention is to provide a spring activated rodent trap which has a flat state prior to activation and a curved state after activation.

Yet another object of the present invention is to provide a spring activated rodent trap which can be manufactured in volume at a relatively low unit cost.

In accordance with the present invention, there is provided a spring activated adhesive rodent trap which includes a flat base member on which an adhesive layer is deposited on an upper surface. A bi-stable spring member is attached to a lower surface of the base member. When a rodent ventures onto the adhesive layer, the action of the rodent in trying to free itself causes the bi-stable spring to snap into a curved configuration. The bi-stable spring forces the base into a curved state which envelops and conceals the rodent.

These and other aspects of the invention will become apparent from the following description of the preferred embodiment taken in conjunction with the following drawings, although variations and modifications may be affected without departing from the spirit and scope of the novel concepts of the disclosure.

### BRIEF DESCRIPTION OF THE DRAWINGS

FIG. 1 is a top plan view of a spring activated adhesive rodent trap;

FIG. 2 is a side elevation view of the rodent trap of FIG. 1 taken along the line 2-2 of FIG. 1;

FIG. 3 is a bottom plan view taken along the line 3-3 of FIG. 2;

FIG. 4 is an end view taken along the line 4-4 of FIG. 2 drawn to an enlarged scale;

FIG. 5 is a side view of the activation spring of the rodent trap of FIG. 1 with the activation spring shown removed from the trap and shown in the flat configuration;

FIG. 6 is an end view of the activation spring taken along the line 6-6 of FIG. 5;

FIG. 7 is a side view of the activation spring with the activation spring shown in the curved configuration;

FIG. 8 is a cross-sectional view taken along the line 8-8 of FIG. 7; and

FIG. 9 is a side view of the rodent trap of FIG. 1 showing the rodent trap snapped into the curved configuration and entrapping a rodent.

### DETAILED DESCRIPTION OF THE INVENTION

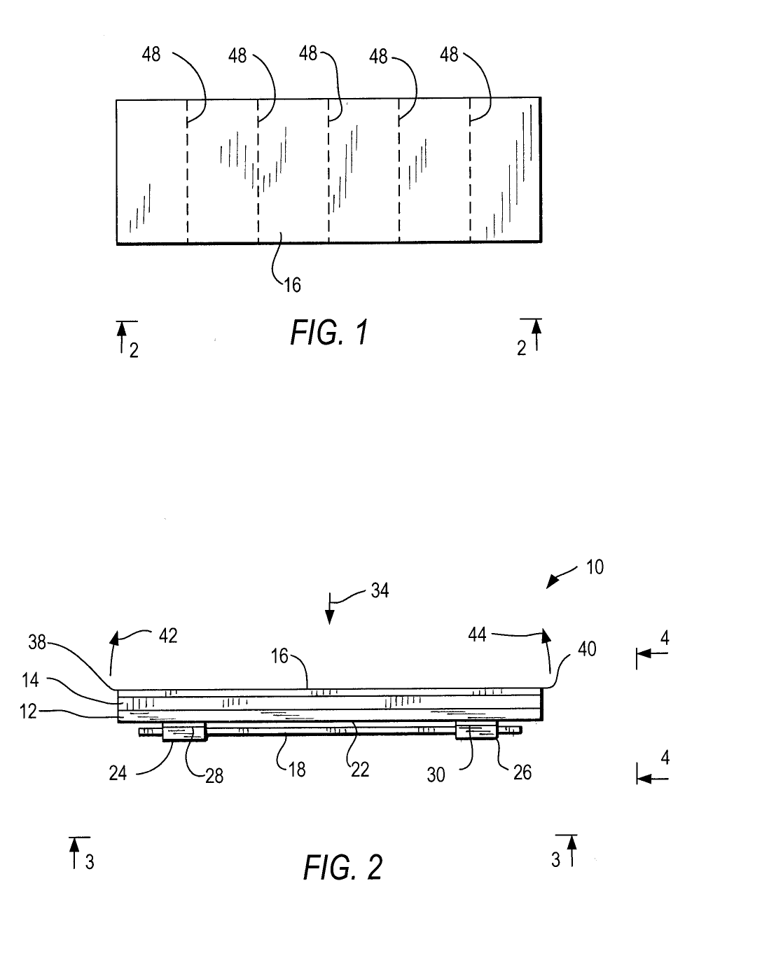

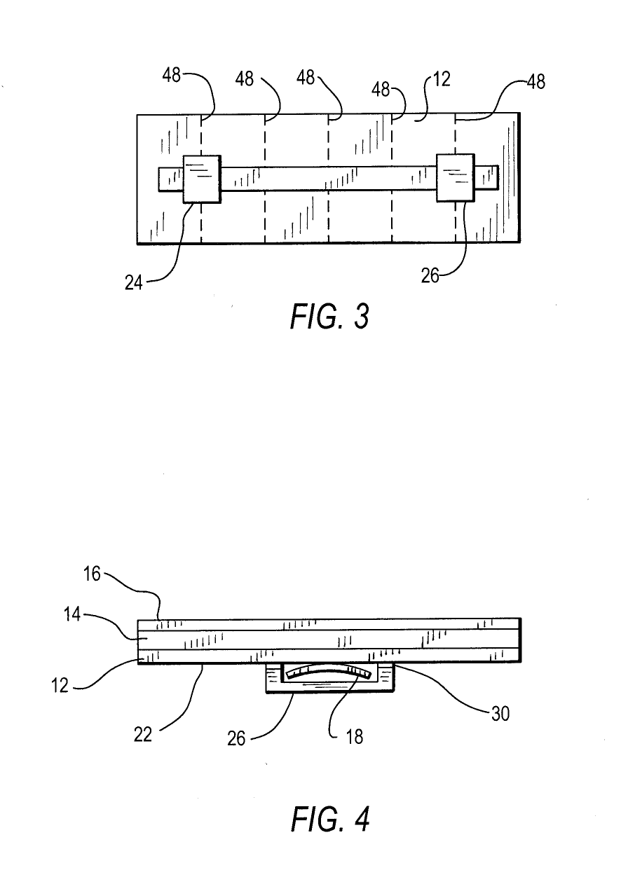

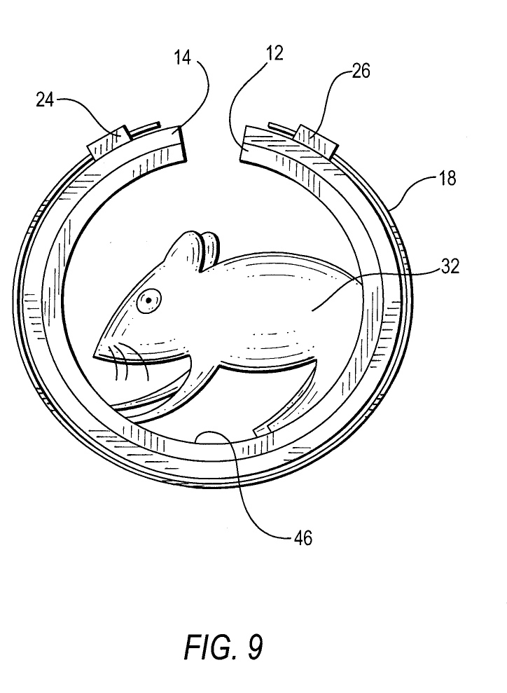

With reference to the drawings, there is shown in FIGS. 1-9 a spring activated adhesive rodent trap 10 which includes a generally rectangular base member 12, an adhesive layer 14, a release sheet 16 and an activation spring 18. The base member 12 may be formed of plastic, cardboard or paper board and, in a preferred embodiment, may include a plurality of transversely oriented score lines indicated schematically by broken lines 48 which enable the activation spring 18 to quickly move the trap 10 from the flat and open configuration shown in FIGS. 1-4 to the closed configuration shown in FIG. 9 when the trap 10 is activated by a rodent 32 in a manner which will be presently described.

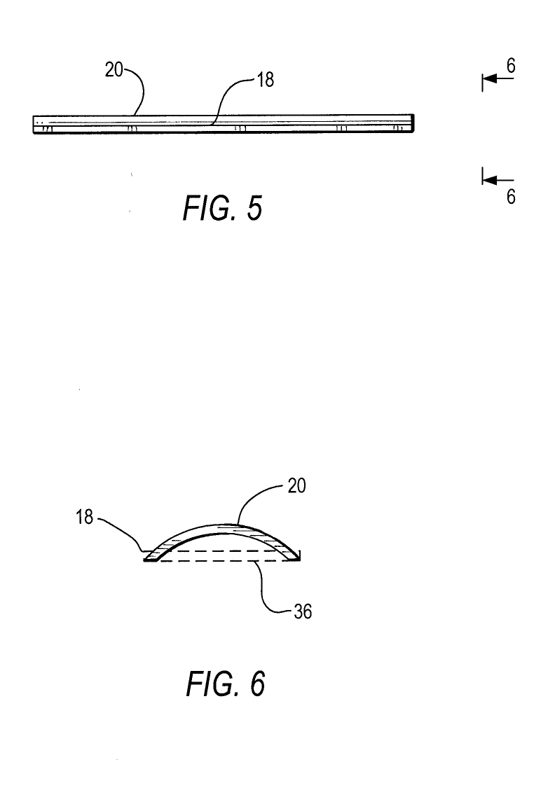

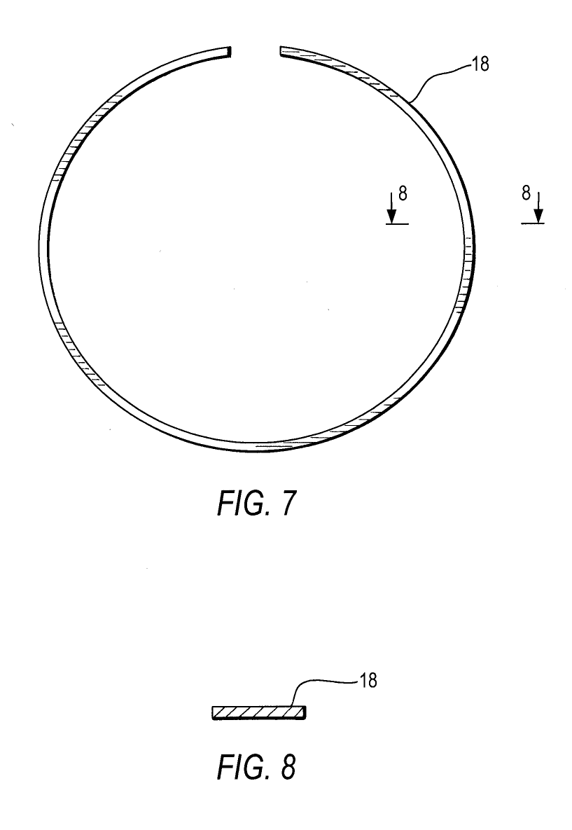

The activation spring 18 is a flat spring which is a bi-stable member which is capable of maintaining either one of two stable configurations shown in FIGS. 5 and 7. In the open configuration shown in FIGS. 5 and 6, the spring 18, which for clarity of illustration has been shown removed from the trap 10, is substantially flat when viewed as depicted in FIG. 5, with a transverse curve which maintains the longitudinally flat or extended configuration. The transverse curve which extends along the length of the spring 18 defines a generally transverse curved surface 20 which is best shown in FIG. 6.

This curvature 20 helps maintain the configuration of the spring 18 shown in FIG. 5.

The spring 18 is attached to the lower surface 22 of the base member 12 by a pair of transverse clips 24, 26 which may be formed of plastic or paperboard. The clips 24, 26 may be attached to the base member 12 by adhesive layers 28, 30.

The spring 18 maintains the base member 12 and the adhesive layer 14 in the flat configuration shown in FIGS. 1-4. The spring may be made of metal or plastic.

The spring 18 is a bi-stable member in the sense that the configuration of the spring is stable in the curved configuration shown in FIG. 7 and is also stable in the flat configuration shown in FIG. 5.

During use, the release sheet 16 is removed and the trap 10 is placed on a flat surface. Bait or a rodent attractant material may be placed in the area indicated by the reference numeral 46 in FIG. 9.

When a rodent 32 moves onto the adhesive layer 14, the combination of the weight of the rodent 32 acting in the direction shown by the arrow 34 in FIG. 2 and the agitated motion of the rodent 32 flattens the curved surface 20 of the spring 18 toward the configuration indicated by the broken lines 36. As the curved surface 20 of the spring 18 is flattened, the area moment of inertia of the cross-section of the spring 18 (or resistance to bending) is reduced and the spring 18 snaps into the configuration shown in FIG. 7 and the ends 38 and 40 of the trap 10 move quickly in the directions shown by the arrows 42 and 44 in FIG. 2.

In the closed configuration shown in FIG. 9, the rodent 32 is enclosed and entrapped by the adhesive layer 14 and the base member 12 and the trap 10 and the rodent 32 may be disposed of in a convenient and hygienic manner.

The foregoing specific embodiment of the present invention as set forth in the specification herein is for illustrative purposes only. Various deviations and modifications may be made within the spirit and scope of this invention, without departing from a main theme thereof.

What is claimed is:

1. A spring activated adhesive rodent trap comprising:
a base member having a first surface and a second surface;
an adhesive layer disposed on said first surface of said base member, and
an activation spring disposed on said second surface of said base member.

2. The spring activated adhesive rodent trap as claimed in claim 1 wherein said activation spring comprises:
a bi-stable member.

3. The spring activated adhesive rodent trap as claimed in claim 1 further comprising:
a mechanical connection disposed connecting said activation spring and said base member.

4. The spring activated adhesive rodent trap as claimed in claim 1 wherein said activation spring comprises:
an elongated member.

5. The spring activated adhesive rodent trap as claimed in claim 1 wherein said base member comprises:
a rectangular member having a pair of relatively longer edges and a pair of relatively shorter edges.

6. The spring activated adhesive rodent trap as claimed in claim 1 further comprising:
a release layer disposed on said adhesive layer.

7. The spring activated adhesive rodent trap as claimed in claim 5 wherein said activation spring is disposed generally parallel to said pair of relatively longer edges.

8. The spring activated adhesive rodent trap as claimed in claim 5 wherein said base member comprises:
a cardboard member.

9. The spring activated adhesive rodent trap as claimed in claim 5 wherein said base member comprises:
a paperboard member.

10. The spring activated adhesive rodent trap as claimed in claim 5 wherein said base member comprises:
a plastic member.

11. The spring activated adhesive rodent trap as claimed in claim 5 wherein said base member comprises:
a plurality of scored portions.

12. The spring activated adhesive rodent trap as claimed in claim 5 wherein said base member comprises:
a plurality of scored portions with said scored portions disposed parallel to said relatively shorter edges of said base member.

13. The spring activated adhesive rodent trap as claimed in claim 5 wherein said activation spring comprises:
a metal activation spring.

14. The spring activated adhesive rodent trap as claimed in claim 5 wherein said activation spring comprises:
a plastic activation spring.

15. The spring activated adhesive rodent trap as claimed in claim 5 wherein said activation spring comprises:
a first relatively flat state and
a second curved state.

16. The spring activated adhesive rodent trap as claimed in claim 1 wherein said activation spring comprises:
a transversely curved portion.

17. The spring activated adhesive rodent trap as claimed in claim 1 wherein said activation spring snaps from a relatively flat configuration to a curved configuration.
